(19) United States
(12) Patent Application Publication
(10) Pub. No.: US 2011/0212878 A1
(43) Pub. Date: Sep. 1, 2011

(54) PRODUCT AND METHOD OF TREATMENT

(75) Inventors: Neil ATKIN, Hull (GB); Diane KELLY, Hull (GB); Malcolm Tom McKECHNIE, Hull (GB); James YOUNG, Hull (GB)

(73) Assignee: Reckitt Benckiser (UK) Limited, Slough (GB)

(21) Appl. No.: 13/089,732

(22) Filed: Apr. 19, 2011

Related U.S. Application Data
(62) Division of application No. 11/815,647, filed on Aug. 27, 2007.

(30) Foreign Application Priority Data
Feb. 7, 2005 (GB) 0502408.8

(51) Int. Cl. C11D 3/26; C11D 17/00

(52) U.S. Cl. 510/406; 510/405

(57) ABSTRACT

A method and related packaged product for forming a surface treatment liquid involves contacting two solids to form a liquid, particularly an ionic liquid under ambient conditions at the locus of use.

### FIELD OF THE INVENTION

The present invention relates to methods of treating surfaces with a liquid which is formed on the surface to be treated as a consequence of the mutual contact of two solids and to packaged consumer products comprising such solids. More specifically it relates to methods of treatment or cleaning of surfaces using ionic liquids formed from the interaction between two compounds which are both solid at ambient temperatures

### BACKGROUND TO THE INVENTION

Ionic liquids are ionic compounds that are in the form of a liquid at ambient temperatures. They are essentially molten salts with a low melting point, and consequently can be used as highly polar solvents. As a result of their very low vapour pressures, in contrast to conventional solvents, they have been extensively studied as environmentally acceptable alternatives to conventional organic solvents for a broad range of organic synthetic applications.

Ionic liquids also have applications in electrochemistry, for example, in fuel cells, electrodeposition processes and other electrochemical applications. Additionally, ionic liquids have been shown to be effective in applications where water-based chemistry can be potentially disruptive or harmful.

The patent applications WO 00/56700, 02/26381 and 02/26701 disclose a multitude of ionic liquids that are liquids at or near ambient temperature. They also disclose the use of such liquids as solvents. Many of the ionic liquids disclosed in these applications can are formed as compound of two materials where each of the two materials is a solid. WO 2004/003120 discloses compositions comprising ionic liquids and their use in surface or air treating compositions.

Current products for the treatment or cleansing of surfaces often include particulate solids to aid cleansing by assisting with the abrasion of soil from the surface. Such systems have the disadvantage that the particulate solids may be left as unattractive, visible residue.

Furthermore, it is desirable to have reactive chemicals included within cleaning liquids, but if the cleaning liquid is water based, the reactive compounds are likely to chemically degrade or react with other ingredients on storage. If the liquid is a non-aqueous liquid, such as a nonionic alcohol ethoxylate, then the cleaning liquid is likely to absorb moisture on storage or after exposure to the atmosphere. Because the product is in the form of a liquid, water can rapidly diffuse into it leading to degradation, reaction and even the potential for exploding packages caused by release of gaseous reaction products.

The conventional means for overcoming such a problem is to provide the product in powdered or granular form, such that water uptake is reduced. This has the disadvantage that the user has to add water to the product prior to use, adding an extra step to the process and making an early commencement of any reaction of the reactive chemical which may be inefficient. If the product is used in a mechanical device such as a washing machine, it can lead to problems such as mechanical loss, where undissolved solid lodges in parts of the machine, particularly in the sump, or to residues, where the undissolved particulate is left on the articles to be cleansed.

### SUMMARY OF THE INVENTION

It has now been found that many of the problems for prior art surface treatment and cleansing compositions can be addressed through the use of solids which interact to form liquids, particularly ionic liquids at ambient temperatures.

In a first aspect, the invention provides a method of forming a surface treatment liquid comprising bringing into mutual contact a first solid and a second solid wherein the first and second solids interact upon mutual contact to form a liquid characterised in that the method is carried out at the locus of use.

### BRIEF DESCRIPTION OF THE DRAWINGS

FIG. 1 illustrates in a perspective view an embodiment of the invention having first and second solids both in the form of friable or waxy bars or sticks or billets, packaged with their long axes mutually parallel so that the sticks bars or billets are side by side, but with a barrier between the sticks to prevent them form contacting each other on storage to form the liquid prematurely.

FIG. 2 shows a cross-section through the embodiment of the invention depicted on FIG. 1.

### DETAILED DESCRIPTION OF THE INVENTION

The first and second solids may be any compositions that are solid under ambient conditions, including composites comprising both solid and liquid phases, provided that their structure is such that they behave as solids. In other words their shape does not significantly deform (meaning by more than 1% strain) under their own weight when stored as a cube for 30 days on one face at sea level. Preferably the first and second solids have a melting temperature of 40° C. or more, more preferably 60° C. or more, even more preferably 80° C. or more.

The liquid formed by the interaction between the first and second solids preferably has a freezing temperature of 20° C. or less, more preferably 0° C. or less, even more preferably −10° C. or less. Although it is preferred that the liquid should have no solid particles dispersed within it, it may suitably comprise dispersed solid particles provided that the liquid has a dynamic viscosity of 100,000 mm²sec⁻¹ measured using a capillary viscometer at 25° C.

However, also included, as an aspect of the invention, is the situation where the first and second solids only interact to form a liquid when heated above ambient temperature. This aspect is useful for treating heated surfaces such as hot plates or ovens, or for use when ironing clothing.

There are no fixed standard methods for determining the freezing and melting temperatures for composite solids and liquids. For the purposes of this specification, if a material held at a certain temperature behaves as a solid, as described above, then that temperature is below its melting point. Conversely, if a material is heated to 100° C., held at that temperature for 10 minutes, cooled to a certain temperature and held at that certain temperature for 30 minutes, then if the material is a liquid, as defined above, that certain temperature is above the freezing temperature of the material.

By locus of use, it is meant that the first and second solids are not brought together to form the liquid until they are in the location where the liquid is to be used, and they will have been transported to that location maintained in solid form. It is preferred that the first and second solids are not brought together until immediately prior to the intended use of the liquid, by which is meant less than an hour before use, preferably less than 10 minutes before use, more preferably less than one minute before use. Most preferably, the first and second solids are brought together during use.

This leads to a second aspect of the invention, which is method of treating a surface comprising the application of a first solid and a second solid to the surface whereby the two solids are brought into mutual contact with each other and with the surface and wherein the first and second solids interact upon mutual contact to form a liquid.

Although a further solvent, particularly water, may also be employed in the methods of the invention, it is preferred that no solvent is added or used. Solvent may be subsequently used, in particular water may be used, when it is necessary to dissolve or rinse surface treatment liquid.

The resulting liquid may be left upon the surface as a surface treatment agent (for instance as a polish or antistatic agent or refractive index modifier or carrier for a fragrance).

The resulting liquid may also be used to clean the surface. Another aspect of the invention is a method of cleaning a surface comprising the sequential steps:

i) the application of a first solid and a second solid to the surface whereby the two solids are brought into mutual contact with each other and with the surface and wherein the first and second solids interact upon mutual contact to form a liquid
ii) cleaning the surface with the liquid and
iii) removal of liquid and soil from the surface.

Some liquid may be allowed to remain on the surface after cleaning without risk of formation of visible particulate residues.

It is preferred to rub the surface to be cleaned whereby the first and second solids abrade the soil during the formation of the liquid.

The first and second solids may be applied to the surface, preferably a hard surface, then wiped with a cloth or wipe.

The term “surface” includes both hard and soft surfaces. “Hard surface” includes ceramics, glass, stone, plastics, marble, metal and/or wood surfaces, such as, in the household environment for example, bathroom and kitchen hard surfaces such as sinks, bowls, toilets, panels, tiles, worktops, dishes, and the like.

The term “soft surface” includes textiles, clothing, carpets, curtains, upholstery, textile or fabric covered articles, and the like.

The first solid and second solid may be any materials which exhibit eutectic behaviour; i.e. the mixture has a lower melting point than either of the individual components. An example would be where the first solid is an alcohol ethoxylate with a singly unsaturated cis-alkyl chain and the second solid is an alcohol ethoxylate with a saturated alkyl chain.

However, it is preferred that the first and second solids are materials which interact together to form an ionic liquid.

A preferred material for use as a component of the first solid (or the second solid) is a quaternary ammonium compound according to formula I

R₁R₂R₃R₄N⁺X⁻ I

wherein R₁, R₂ and R₃ are each independently hydrogen, a C₁ to C₅ alkyl or a C₆ to C₁₀ cycloalkyl group or wherein R₂ and R₃ taken together represent a C₄ to C₁₀ alkylene group such that R₂R₃ and the N atom of formula I form a 5- to 11-membered heterocyclic ring,
and wherein R₄ differs from any of R₁, R₂ and R₃ and is hydrogen, a C₆ to C₁₂ alkyl or cycloalkyl group substituted with at least one substituent selected from the group consisting of OH, Cl, Br, F, I, NH₂, CN, NO, COOR₅, CHO, COR and OR₅ wherein R₅ is a C₁ to C₁₀ alkyl or cycloalkyl group,
and X⁻ is a halogen or methosulphate counter-ion. A particularly preferred compound according to formula I is choline chloride

Mixtures of materials according to formula I may be used, and any reference to a compound according to formula I includes mixtures thereof.

Preferably, 1, 2 or 3 of the substituents R₁, R₂ and R₃ is hydrogen. Such compounds are disclosed, for example, in WO 2005/097731.

The first solid suitably comprises 50% or more by weight of compound according to formula I, preferably 70% or more, more preferably 90% or more, even more preferably 95% or more.

When the first or second solid comprises a compound according to formula I as described above, the other, second or first solid respectively preferably comprises one or more of the following compounds A, B, C, D, E or F, or mixtures thereof. The second solid suitably comprises a sum total of 50% or more by weight of compounds according to A,B,C,D,E,F or mixtures thereof, preferably 70% or more, more preferably 90% or more, even more preferably 95% or more.

Compound A is a halide selected from the group consisting of the halides of zinc, tin, iron aluminium and mixtures thereof. Zinc and aluminium halides are preferred, particularly zinc halides.

Compound B is a hydrated salt selected from the group consisting of hydrated salts that are halides, nitrates, sulphates or acetates of magnesium, calcium, iron, aluminium, zinc, and mixtures thereof. Salts of magnesium, calcium and zinc are preferred. Zinc nitrate hexahydrate is particularly preferred.

Compound C is a compound of formula R₆COOH wherein R₆ is selected from the group consisting of C₁ to C₈ alkyl, an aryl group, and a C₇ to C₁₂ alkaryl group, the alkyl, aryl or alkaryl groups being optionally further substituted with one or more substituents selected from the group consisting of OH, Cl, Br, F, I, NH₂, CN, NO2, COOR₇, CHO, COR₇ and OR₇ wherein R₇ is selected from the group consisting of H, C₁ to C₁₀ alkyl and cycloalkyl. Examples of compounds C include oxalic acid, citric acid, p-amino benzoic acid, benzoic acid, tartaric acid, particularly L-tartaric acid, glutamic acid (particularly the L form) and malonic acid

Compound D is a compound of formula R₈R₉NH wherein R₈ and R₉ are independently selected from the group consisting of H, C₁ to C₈ alkyl, an aryl group, and a C₇ to C₁₂ alkaryl group, the alkyl, aryl or alkaryl groups being optionally further substituted with one or more substituents selected from the group consisting of OH, Cl, Br, F, I, NH₂, CN, NO2, COOR₇, CHO, COR₇ and OR₇ wherein R₇ is selected from the group consisting of H, C₁ to C₁₀ alkyl and cycloalkyl.

Compound E is a compound of formula R₁₀CZNH₂ wherein R₁₀ is selected from the group consisting of NH₂, C₁ to C₈ alkyl, an aryl group, and a C₇ to C₁₂ alkaryl group, the alkyl, aryl or alkaryl groups being optionally further substituted with one or more substituents selected from the group consisting of OH, Cl, Br, F, I, NH₂, CN, NO2, COOR₇, CHO, COR₇ and OR₇ wherein R₇ is selected from the group consisting of H, C₁ to C₁₀ alkyl and cycloalkyl, and wherein Z is selected from O and S. A particularly preferred compound E is Urea.

Compound F is a compound of formula R₁₁OH wherein R₁₁ is selected from the group consisting of C₁ to C₈ alkyl, an aryl group, and a C₇ to C₁₂ alkaryl group, the alkyl, aryl or alkaryl groups being optionally further substituted with one or more substituents selected from the group consisting of OH, Cl, Br, F, I, NH₂, CN, NO2, COOR₇, CHO, COR₇ and OR₇ wherein R₇ is selected from the group consisting of H, C₁ to C₁₀ alkyl and cycloalkyl. An example of compound F is fructose.

The first solid, the second solid or both the first and second solids may further comprise other adjuncts provided that these do not compromise the functioning of the invention. The adjuncts used are suitably those related to the surface treatment process envisioned for use with the method of the invention.

Hence for cleansing surfaces, adjuncts may include surfactants, fragrances, bactericides, fungicides, virucides, bleaches, reducing agents, antistatic agents, insecticides, insect repellents. Preferably adjuncts are employed which are soluble in the liquid resulting from the contact of the first and second solids.

The first and/or second solids may contain chemically reactive species, such as species that might lose their activity or react with other ingredients of the first and/or second solids when they come into contact with atmospheric moisture or when they dissolve in water or an ionic liquid.

The invention has the advantage that such chemically reactive materials may be held in solid, relatively unreactive form, entrapped in a solid matrix, until their reactivity is released at the locus and/or time of use of the surface treating liquid.

For example, the chemically reactive material may be a bleach such as hydrogen peroxide or a hydrogen peroxide source such as sodium percarbonate or sodium perborate. When such a material is present as a component of the first or second solid, the other solid may incorporate a bleach precursor, for instance tetra-acetyl ethylene diamine, which forms a more reactive bleach when contacted with a source of peroxide; peracetic acid in this specific example.

A particular example of this is where one of the solids comprises urea according to compound E as described above, then hydrogen peroxide may also be present as the addition compound urea hydrogen peroxide.

Hence, another aspect of the invention involves the use of the method of the invention as described above, wherein the first and/or second solids comprise reactive ingredients which are reactive in solution, to inhibit the reaction of the reactive ingredients prior to use.

Another aspect of the invention involves the use of the method of the invention as described above, wherein the first and/or second solids comprise volatile ingredients which are reactive in solution, to inhibit the loss to the atmosphere of the reactive ingredients prior to use.

This aspect is of the invention has the advantage that such volatile materials may be held in solid, relatively involatile form, entrapped in a solid matrix, until they are released at the locus and/or time of use of the surface treating liquid. This can lead to the advantage of a sudden release of, say, fragrance providing a cue to the user of the activity of the composition. It also allows reduction in loss of ingredients on storage without the need for impervious packaging materials.

Another aspect of the invention involves the use of the method of the invention as described above, wherein the first and second solids comprise respectively first and second mutually reactive ingredients which are mutually reactive with each other in solution, to prevent the mutual reaction of the reactive ingredients prior to use.

This aspect is of the invention has the advantage that the mutual reaction between the first and second mutually reactive ingredients is delayed until they are released at the locus and/or time of use of the surface treating liquid. This can lead to the advantage of a sudden release of, say, heat or gas bubbles providing a cue to the user of the activity of the composition.

In one aspect of the invention, the first and second solids may be loosely entrapped within a woven or non-woven wipe or cloth, whereby they are brought into contact when the wipe or cloth is used to clean a surface.

Another aspect of the invention concerns a packaged surface treatment product comprising a package, the package comprising a first region for holding a first solid and a second region for holding a second solid, whereby the first and second solids are prevented from mutual contact prior to dispensing from the package. Preferably the regions are containers with dispensing apertures. The dispensing apertures are preferably fitted with a closure means such as a lid, the closure means being removably held in place, preferably with a seal to prevent the ingress of atmospheric moisture.

The physical form of the first solid and of the second solid may suitably be independently selected from powder, granule, tablet (preferably a friable tablet) and prill. Preferably both solids are in the form of powder or granules, preferably granules with a weight median particle diameter from 20 to 2000 micrometres, more preferably 40 to 1000 micrometres.

In another preferred aspect of the invention, one or both of the first and second solids may be in the form of a solid bar or rod, such as an extruded bar or billet, similar in size and appearance to a soap bar or lipstick. In this aspect of the invention, the first and/or second solids may be deposited on a surface in the same way that lipstick is deposited on lips by rubbing.

In the methods according to the invention, the first and second solids may be brought into contact in a container or vessel prior to use at the locus of use. For instance if the first and second solids are both in the form of granules, then they may be mixed together in a cup, for example with a spoon, to form the liquid. If the surface treatment liquid is to be used directly on a surface, the two solids may be brought into contact by sprinkling them directly on to the surface when bringing them into contact by wiping with a cloth or wipe.

If the liquid is to be used in a fabric washing machine or automatic dishwashing machine, the two solids may be placed or poured into the dispensing drawer or holder of the machine, where their mutual contact will lead to the formation of a liquid, even without the need for mixing or stirring. This gives the advantage of more rapid dispersion compared to conventional powders when contacted with water. Moreover, it is difficult to store aqueous liquid detergent products containing peroxide bleaches because of their inherent chemical instability. The method of the invention provides a means to obtain the good dispensing characteristics of a liquid detergent product combined with the ability to comprise a bleaching system. This is because the product is stored as a solid, only forming a liquid at the locus of use and preferably near the time of use.

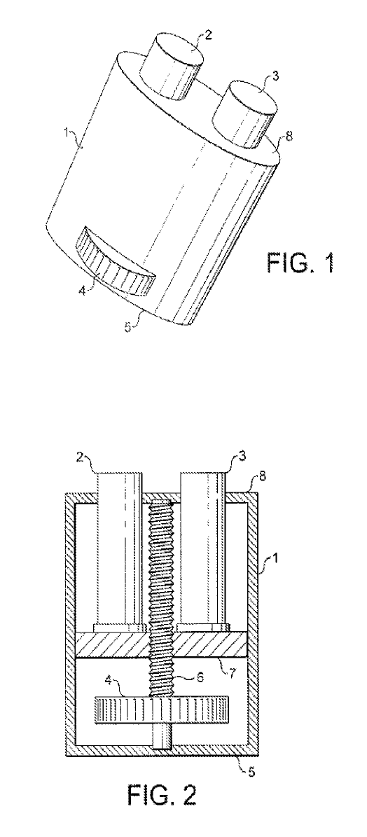

Another mode of use of the invention involves having the first and second solids both in the form of friable or waxy bars or sticks or billets, packaged with their long axes mutually parallel so that the sticks bars or billets are side by side, but with a barrier between the sticks to prevent them form contacting each other on storage to form the liquid prematurely. The barrier may be air or may be a polymeric film or any suitable means to prevent contact. In this mode, the sticks are grasped by a user and rubbed against the surface to be treated whereby both the first and second solids are rubbed against the surface to be treated, thus bringing the two solids together at the locus of use. FIG. 1 shows an embodiment of the invention according to this mode of use in perspective view. FIG. 2 shows a cross section through the embodiment. The package has an outer wall (1), a base (5) and a top surface (8). The top surface has two openings through which the solid sticks (2 and 3) protrude. The solid sticks (2 and 3) are made up of the first and second solids of the invention respectively. The two sticks are firmly mounted to a platform 7, which slides snugly against the inner wall of the package. The threaded stud 6 is rotatably mounted to the inner face of the base (5) and the top surface (8) and mates with a taped hole in the platform (7). The knurled knob (4) is rigidly mounted to the stud (6). When the knob (4) is turned with respect to the package, the platform is caused to move up by the threads on the stud pushing the threads in the taped hole, leading to the sticks (2 and 3) being pushed outwards from the package. The embodiment is used by a person grasping the outer surface of the package (1) and rubbing the sticks (2 and 3) against the surface to be treated. This embodiment is particularly suitable as a fabric stain pre-treatment device.

In a simpler form, the surface may be rubbed with one bar of the first solid then rubbed with a second bar of the second solid.

An example of the invention was prepared where the first solid was a granular powder of choline chloride and the second solid was a crystalline powder of zinc nitrate hexahydrate. The solids powders were sprinkled onto a soiled tile surface at 25° C. and, when rubbed on the surface with a dry cotton cloth, were found to form an ionic liquid on the soiled surface which could be used to assist with the cleaning.

Further examples are i) urea hydrogen peroxide as the first solid and choline chloride as the second solid ii) urea as the first solid and choline chloride as the second solid and iii) citric acid as the first solid and choline chloride as the second solid.

An example of a system where the liquid is only formed as a consequence of heating above ambient temperature is oxalic acid with choline chloride, where the liquid is formed at about 50° C.

1) A method of forming a surface treatment liquid comprising bringing into mutual contact a first solid and a second solid wherein the first and second solids interact upon mutual contact to form a liquid characterised in that the method is carried out at the locus of use.

2) A method of treating a surface comprising the application of a first solid and a second solid to the surface whereby the two solids are brought into mutual contact with each other and with the surface and wherein the first and second solids interact upon mutual contact to form a liquid.

3) A method of cleaning a surface comprising the sequential steps:
i) the application of a first solid and a second solid to the surface whereby the two solids are brought into mutual contact with each other and with the surface and wherein the first and second solids interact upon mutual contact to form a liquid
ii) cleaning the surface with the liquid and
iii) removal of liquid and soil from the surface.

4) A method according to claim 3 wherein some of the liquid is allowed to remain on the surface.

5) A method according to any preceding claim wherein the melting point of the first solid is 40° C. or more, the melting point of the second solid is 40° C. or more and the freezing point of the liquid is 20° C. or less.

6) A method according to any preceding claim wherein the liquid is an ionic liquid.

7) A method according to any preceding claim wherein the first solid comprises a quaternary ammonium compound according to formula I
R₁R₂R₃R₄N⁺X⁻ I
wherein R₁, R₂ and R₃ are each independently hydrogen, a C₁ to C₅ alkyl or a C₆ to C₁₀ cycloalkyl group or wherein R₂ and R₃ taken together represent a C₄ to C₁₀ alkylene group such that R₂R₃ and the N atom of formula I form a 5- to 11-membered heterocyclic ring,
and wherein R₄ differs from any of R₁, R₂ and R₃ and is hydrogen, a C₆ to C₁₂ alkyl or cycloalkyl group substituted with at least one substituent selected from the group consisting of OH, Cl, Br, F, I, NH₂, CN, NO, COOR_{S}, CHO, COR and OR₅ wherein R₅ is a C₁ to C₁₀ alkyl or cycloalkyl group,
and X⁻ is a halogen or methosulphate counter-ion.

8) A method according to claim 7 wherein the second solid is a halide of zinc, tin, iron aluminium or a mixture thereof.

9) A method according to claim 7 wherein the second solid comprises a hydrated salt selected from the group consisting of halides, nitrates, sulphates or acetates of magnesium, calcium, iron, aluminium, zinc and mixtures thereof.

10) A method according to claim 7 wherein the second solid comprises a compound of formula R₆COOH wherein R₆ is selected from the group consisting of C₁ to C₈ alkyl, an aryl group, and a C₇ to C₁₂ alkaryl group, the alkyl, aryl or alkaryl groups being optionally further substituted with one or more substituents selected from the group consisting of OH, Cl, Br, F, I, NH₂, CN, NO2, COOR₇, CHO, COR₇ and OR₇ wherein R₇ is selected from the group consisting of H, C₁ to C₁₀ alkyl and cycloalkyl.

11) A method according to claim 7 wherein the second solid comprises a compound of formula R₈R₉NH wherein R₈ and R₉ are independently selected from the group consisting of H, C₁ to C₈ alkyl, an aryl group, and a C₇ to C₁₂ alkaryl group, the alkyl, aryl or alkaryl groups being optionally further substituted with one or more substituents selected from the group consisting of OH, Cl, Br, F, I, NH₂, CN, NO2, COOR₇, CHO, COR₇ and OR₇ wherein R₇ is selected from the group consisting of H, C₁ to C₁₀ alkyl and cycloalkyl.

12) A method according to claim 7 wherein the second solid comprises a compound of formula R₁₀CZNH₂ wherein R₁₀ is selected from the group consisting of NH₂, C₁ to C₈ alkyl, an aryl group, and a C₇ to C₁₂ alkaryl group, the alkyl, aryl or alkaryl groups being optionally further substituted with one or more substituents selected from the group consisting of OH, Cl, Br, F, I, NH₂, CN, NO2, COOR_{S}, CHO, COR₇ and OR₇ wherein R₇ is selected from the group consisting of H, C₁ to C₁₀ alkyl and cycloalkyl, and wherein Z is selected from O and S.

13) A method according to claim 7 wherein the second solid comprises a compound of formula R₁₁OH wherein R₁₁ is selected from the group consisting of C₁ to C₈ alkyl, an aryl group, and a C₇ to C₁₂ alkaryl group, the alkyl, aryl or alkaryl groups being optionally further substituted with one or more substituents selected from the group consisting of OH, Cl, Br, F, I, NH₂, CN, NO2, COOR_{S}, CHO, COR₇ and OR₇ wherein R₇ is selected from the group consisting of H, C₁ to C₁₀ alkyl and cycloalkyl.

14) The use of a method as described in claims 1 to 13, wherein the first and/or second solids comprise reactive ingredients that are reactive in solution, to inhibit the reaction of the reactive ingredients prior to use.

15) A packaged surface treatment product comprising a package, the package comprising a first region for holding a first solid and a second region for holding a second solid, whereby the first and second solids are prevented from mutual contact prior to dispensing from the package, and wherein the first and second solids are according to the first and second solids of claims 1 to 13.
